(19) United States
(12) Patent Application Publication
(10) Pub. No.: US 2009/0002352 A1
(43) Pub. Date: Jan. 1, 2009

(54) Driving apparatus and display system using the same

(75) Inventors: Tsung-Hsiang Huang, Changhua County (TW); Chun-Ming Cheng, Taipei County (TW)

Correspondence Address: Joe McKinney Muncy, PO Box 1364, Fairfax, VA, 22038-1364, US

(73) Assignee: PRINCETON TECHNOLOGY CORPORATION

(21) Appl. No.: 12/068,327

(22) Filed: Feb. 5, 2008

(30) Foreign Application Priority Data
Jun. 26, 2007 (TW) 096210367

(51) Int. Cl. G06F 3/038; G09G 3/20; G09G 3/22

(52) U.S. Cl. 345/204; 345/75.2

(57) ABSTRACT

A driving apparatus is provided for driving a display module. The driving apparatus comprises a comparing module, a processing module, and a first converting module. The comparing module is used for comparing an input signal with a feedback signal and generating a comparing signal. The processing module is coupled to the comparing module for processing the comparing signal and generating a processing signal. The first converting module is coupled to the processing module for converting the processing signal to a driving voltage. The driving apparatus drives the display module by the driving voltage.

### BACKGROUND

The invention relates to a driving apparatus, and in particular to a driving apparatus for driving a field emission display (FED).

This section is intended to introduce the reader to various aspects of art, which may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Similar to a general cathode ray tube (CRT), a field emission display (FED) emits light by beaming high-energy electrons to an image component (pixel) of a screen, and the electronic energy is transformed to visible light by excited fluorescent material. A conventional CRT scans a grating of a screen with one or three electron beams. On the contrary, an FED scans color components of each pixel with a fixed electron beam. Comparing distances between a source of electron beams and the screen for a conventional CRT and n electron source and a screen, the distance between an electron source and a screen is very short. In addition, FEDs are energy efficient compared to CRTs. Accordingly, FEDs are suitable for portable electronic devices, such as note book computers, mobile phones, and personal digital assistant (PDA).

Generally, a field emission display (FED) system uses a controller to generate a driving voltage according to image data, and the generated driving voltage is then used to drive the field emission display (FED) to display images. When the information to be displayed comprises a large quantity of image data, the corresponding driving voltage varies from the different image features of each of the image data. When great difference exists between two successive images, the corresponding driving voltages diverge from each other. In this circumstance, the controller must spend a lot of time to generate the driving voltage. For a high quality audio-visual system, accelerating the generation of driving voltages without adding additional circuits is very important.

Accordingly, a driving apparatus is needed to facilitate image display and improve image quality for a display system.

### SUMMARY

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

A driving apparatus is provided for driving a display module. The driving apparatus comprises a comparing module, a processing module, and a first converting module. The comparing module is used for comparing an input signal with a feedback signal and generating a comparing signal. The processing module is coupled to the comparing module for processing the comparing signal and generating a processing signal. The first converting module is coupled to the processing module for converting the processing signal to a driving voltage. The driving apparatus drives the display module by the driving voltage.

A display system implementing a driving apparatus is also provided for displaying an image. The display system comprises a controlling module, a driving apparatus, and a display module. The driving apparatus comprises a comparing module, a processing module, and a first converting module. The controlling module generates a corresponding input signal and an image signal according to image data. The comparing module, coupled with the controlling module, compares the input signal with a feedback signal to accordingly generate a comparing signal. The processing module, coupled with the comparing module, processes the comparing signal to accordingly generate a processing signal. The first converting module, coupled to the processing module, converts the processing signal to a driving voltage. The display module, coupled with the controlling module, the first converting module and the comparing module, displays the image according to the driving voltage and the image signal.

### BRIEF DESCRIPTION OF DRAWINGS

The invention can be more fully understood by reading the subsequent detailed description and examples with references made to the accompanying drawings, wherein:

FIG. 1 illustrates a schematic view of an embodiment of a driving apparatus;

FIG. 2 illustrates a schematic view of an embodiment of a display system.

### DETAILED DESCRIPTION

One or more specific embodiments of the invention are described below. In an effort to provide a concise description of these embodiments, not all features of an actual implementation are described in the specification. It should be appreciated that in the development of any such actual implementation, as in any engineering or design project, numerous implementation-specific decisions must be made to achieve specific developer goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

In the following detailed description, reference is made to the accompanying drawings which form a part hereof, shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the invention. The following detailed description is, therefore, not to be taken in a limiting sense. The leading digit(s) of reference numbers appearing in the figures corresponds to the figure number, with the exception that the same reference number is used throughout to refer to an identical component which appears in multiple figures. It should be understood that the many of the elements described and illustrated throughout the specification are functional in nature and may be embodied in one or more physical entities or may take other forms beyond those described or depicted.

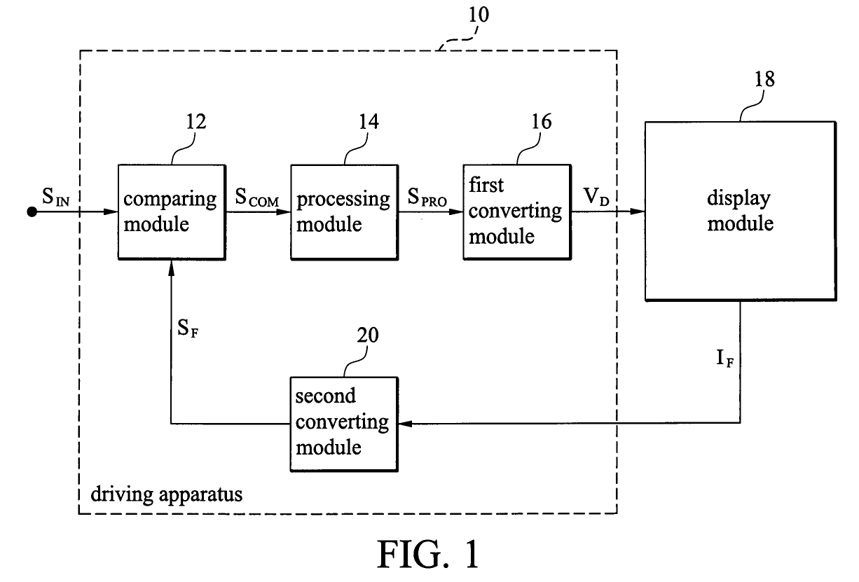

FIG. 1 illustrates a schematic view of an embodiment of a driving apparatus. A driving apparatus 10 is provided for driving a display module 18. The driving apparatus 10 comprises a comparing module 12, a processing module 14, and a first converting module 16. The comparing module 12 compares an input signal S_{IN} with a feedback signal S_{F} to accordingly generate a comparing signal S_{COM}. The comparing module 12 determines a difference value between the input signal S_{IN} and the feedback signal S_{F}, and generates the comparing signal S_{COM} according to the difference value. Here, the comparing module 12 is a comparator, and the feedback signal S_{F} is a feedback current I_{F} output from the display module 18. The processing module 14, coupled with the comparing module 12, accordingly processes the comparing signal S_{COM} to generate a processing signal S_{PRO}. Here, the processing module 14 is a proportional integral and derivative (PID) controller, which performs a proportional integral and derivative process on the comparing signal S_{COM}, and accordingly generates the processing signal S_{PRO}.

The first converting module 16, coupled to the processing module 14, converts the processing signal S_{PRO} to a driving voltage V_{D}. The first converting module 16 can be a digital to analog converter (DAC), converting the processing signal S_{PRO} in a digital format to the driving voltage V_{D} in an analog format. The driving apparatus 10 drives the display module 18 according to the driving voltage V_{D}. According to an embodiment, the display module 18 is a field emission display (FED).

In addition, the driving apparatus 10 further comprises a second converting module 20, receiving and converting the feedback current I_{F} output from the display module 18 and accordingly generating the feedback signal S_{F}. Here, the second converting module 20 is an analog to digital converter (ADC), which converts the feedback current I_{F} in analog format to the feedback signal S_{F} in digital format.

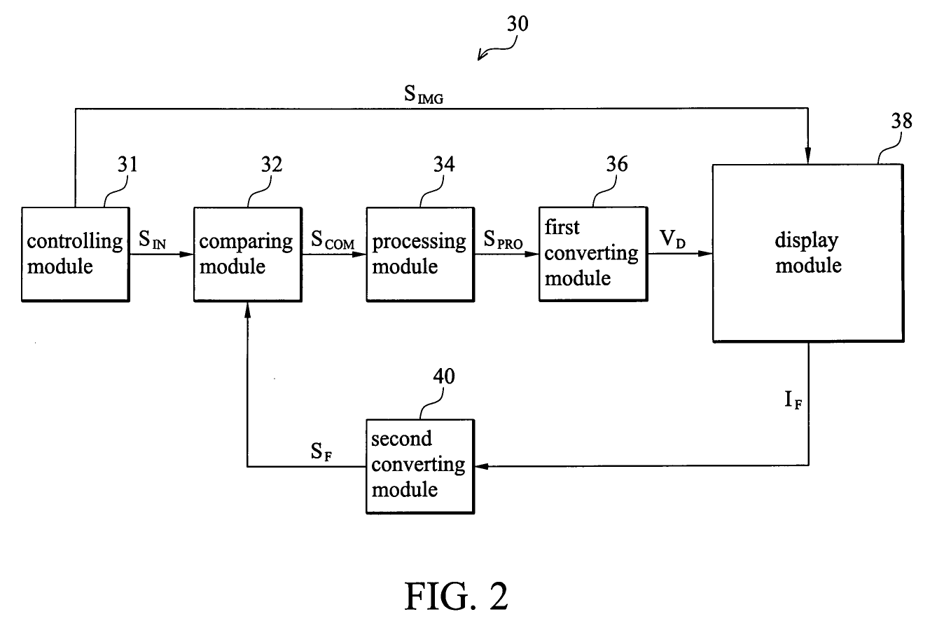

FIG. 2 illustrates a schematic view of an embodiment of a display system. As shown in FIG. 2, a display system 30 is provided for displaying an image (not shown). The display system 30 comprises a controlling module 31, a comparing module 32, a processing module 34, a first converting module 36, and a display module 38. The controlling module 31 generates a corresponding input signal S_{IN} and an image signal S_{IMG} according to image data (not shown). The input signal S_{IN} depends on the image signal S_{IMG}. In other words, value of input signal S_{IN} corresponds to image features of image signal S_{IMG}.

The comparing module 32, coupled with the controlling module 31, compares an input signal S_{IN} with a feedback signal S_{F} to accordingly generate a comparing signal S_{COM}. The comparing module 32 determines a difference value between the input signal S_{IN} and the feedback signal S_{F}, and generates the comparing signal S_{COM} according to the difference value. Here, the comparing module 32 is a comparator, and the feedback signal S_{F} is a feedback current I_{F} output from the display module 38.

The processing module 34, coupled with the comparing module 32, processes the comparing signal S_{COM} to accordingly generate a processing signal S_{PRO}. Here, the processing module 34 is a proportional integral and derivative (PID) controller, which performs a proportional integral and derivative process on the comparing signal S_{COM}, and accordingly generates the processing signal S_{PRO}.

The first converting module 36, coupled to the processing module 34, converts the processing signal S_{PRO} to a driving voltage V_{D}. The first converting module 36 is a digital to analog converter (DAC), converting the processing signal S_{PRO} in a digital format to the driving voltage V_{D} in an analog format. The display module 38, coupled with the controlling module 31, the first converting module 36 and the comparing module 32, displays the image (not shown) according to the driving voltage V_{D} and the image signal S_{IMG}. Here, the display module 38 is a field emission display (FED).

In addition, the display system 30 further comprises a second converting module 40. The second converting module 40 is connected to the comparing module and the display module, respectively. The second converting module 40 receives the feedback current I_{F} output from the display module 38, and converts the feedback current I_{F} to accordingly generate the feedback signal S_{F}. Here, the second converting module 40 is an analog to digital converter (ADC), which converts the feedback current I_{F} in analog format to the feedback signal S_{F} in digital format.

According to the embodiments, the input signal is a reference driving voltage generated by the controlling module according to the image data (not shown). The input signal (reference driving voltage) is then compared with the feedback current output from the display system, and the process is accelerated by the proportional integral and derivative (PID) controller to generate the driving voltage suitable for features of the image data. The driving voltage is then used to drive the display module to display the image specified by the image data. Accordingly, image display is accelerated and image quality is improved for a display system.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A driving apparatus, driving a display module, comprising:
a comparing module, comparing an input signal with a feedback signal to accordingly generate a comparing signal;
a processing module, coupled with the comparing module, processing the comparing signal to accordingly generate a processing signal; and
a first converting module, coupled to the processing module, converting the processing signal to a driving voltage,
wherein the driving apparatus drives the display module according to the driving voltage.

2. The driving apparatus of claim 1, wherein the comparing module determines a difference value between the input signal and the feedback signal, and generates the comparing signal according to the difference value.

3. The driving apparatus of claim 2, wherein the comparing module is a comparator.

4. The driving apparatus of claim 1, wherein the processing module is a proportional integral and derivative (PID) controller, performing a proportional integral and derivative process on the comparing signal, and accordingly generating the processing signal.

5. The driving apparatus of claim 1, wherein the first converting module is a digital to analog converter (DAC), converting the processing signal in a digital format to the driving voltage in an analog format.

6. The driving apparatus of claim 1, wherein the feedback signal is a feedback current output from the display module.

7. The driving apparatus of claim 6, further comprising a second converting module, connected to the comparing module and the display module respectively, receiving and converting the feedback current output from the display module, and accordingly generating the feedback signal.

8. The driving apparatus of claim 7, wherein the second converting module is an analog to digital converter (ADC), converting the feedback current in analog format to the feedback signal in digital format.

9. The driving apparatus of claim 1, wherein the display module is a field emission display (FED).

10. A display system implementing a driving apparatus, displaying an image, comprising:
a controlling module, generating a corresponding input signal and an image signal according to image data;
a driving apparatus, comprising:
a comparing module, coupled with the controlling module, comparing the input signal with a feedback signal to accordingly generate a comparing signal;
a processing module, coupled with the comparing module, processing the comparing signal to accordingly generate a processing signal; and
a first converting module, coupled to the processing module, converting the processing signal to a driving voltage; and
a display module, coupled with the controlling module, the first converting module and the comparing module, displaying the image according to the driving voltage and the image signal.

11. The display system of claim 10, wherein the input signal depends on the image signal.

12. The display system of claim 10, wherein the comparing module determines a difference value between the input signal and the feedback signal, and generates the comparing signal according to the difference value.

13. The display system of claim 12, wherein the comparing module is a comparator.

14. The display system of claim 10, wherein the processing module is a proportional integral and derivative (PID) controller, performing a proportional integral and derivative process on the comparing signal, and accordingly generating the processing signal.

15. The display system of claim 10, wherein the first converting module is a digital to analog converter (DAC), converting the processing signal in a digital format to the driving voltage in an analog format.

16. The display system of claim 10, wherein the feedback signal is a feedback current output from the display module.

17. The display system of claim 16, further comprising a second converting module, connected to the comparing module and the display module respectively, receiving and converting the feedback current output from the display module, and accordingly generating the feedback signal.

18. The display system of claim 17, wherein the second converting module is an analog to digital converter (ADC), converting the feedback current in analog format to the feedback signal in digital format.

19. The display system of claim 10, wherein the display module is a field emission display (FED).
